(19) United States
(12) Patent Application Publication
(10) Pub. No.: US 2004/0118467 A1
(43) Pub. Date: Jun. 24, 2004

(54) Method and apparatus for controlling fluid leaks in a pipe connection

(76) Inventor: Rick Pirart, Bentley (CA)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/731,953

(22) Filed: Dec. 10, 2003

Related U.S. Application Data
(60) Provisional application No. 60/432,043, filed on Dec. 10, 2002.

(51) Int. Cl. F16L 55/16

(52) U.S. Cl. 138/99; 285/14; 285/15

(57) ABSTRACT

A method for controlling fluid leaks in a pipe connection. A first step involves providing a clamp having a circular clamping face with a diversion channel positioned in the circular clamping face and a drain outlet in communication with the diversion channel. A second step involves clamping the clamp around a pipe connection so that any fluids leaking from the pipe connection can only escape by being diverted to the diversion channel. A third step involves positioning a container relative to the drain outlet, so that any fluids passing through the drain outlet from the diversion channel are captured in the container.

### FIELD OF THE INVENTION

The present invention relates to a method and an apparatus for controlling liquid or gaseous fluid leaks in a pipe connection.

### BACKGROUND OF THE INVENTION

It is common for fluids to leak from a connection between two sections of pipe. When the fluid is a gas, the leaking gas is released into the atmosphere. Depending upon the properties of the gas, this may create a safety hazard and an environmental hazard. When the fluid is a liquid, a container is usually positioned below the connection to catch the liquid as it falls from the connection. However, this is often not effective, as high pressure leaks tend to spray from the connection and some low or medium pressure leaks tend to migrate along the pipe.

### SUMMARY OF THE INVENTION

What is required is a more effective method and apparatus for controlling fluid leaks in a pipe connection.

According to one aspect of the present invention there is provided an apparatus for controlling fluid leaks in a pipe connection, which includes a clamp having a circular clamping face adapted to clamp around a pipe connection. A diversion channel is positioned in the circular clamping face of the clamp. A drain outlet is in communication with the diversion channel.

According to another aspect of the present invention there is provided a method for controlling fluid leaks in a pipe connection. A first step involves providing a clamp having a circular clamping face with a diversion channel positioned in the circular clamping face and a drain outlet in communication with the diversion channel. A second step involves clamping the clamp around a pipe connection so that any fluids leaking from the pipe connection can only escape by being diverted to the diversion channel. A third step involves positioning a container relative to the drain outlet, so that any fluids passing through the drain outlet from the diversion channel are captured in the container.

Once the basic teachings of the present invention there are additional features which may be added to further enhance performance of the method and apparatus. For example, a conduit attachment fitting may be positioned on the drain outlet. This enables a conduit to be extended from the drain outlet to the container, this improves flow control when the fluid being captured is a liquid and is absolutely essential when the fluid being captured is a gas. The diversion channel can take a variety of forms. However, it has been determined that it is best adapted to a variety of leakage situations when the diversion channel extends substantially circumferentially around the circular clamping face of the clamp. Similarly, the clamp can take a number of forms. Beneficial results have been obtained through the use of a clamp that has two mating halves. There are various ways of securing the two mating halves around a pipe. Beneficial results have been obtained when a “U” bolt is used to secure the two mating halves together.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is an elevation view of a clamp according to the invention.

FIG. 2 is a side elevation view of a clamp according to the invention

FIG. 3 is a bottom elevation view of the top half of a clamp according to the invention.

FIG. 4 is a top elevation view of the bottom half of a clamp according to the invention.

FIG. 5 is a perspective view of a U-bolt used to secure the clamp.

FIG. 6 is a view of the clamp installed on a pipe connection.

FIG. 7 is an elevation view of a variation of the clamp according to the present invention.

### DETAILED DESCRIPTION OF THE PREFERRED EMBODIMENT

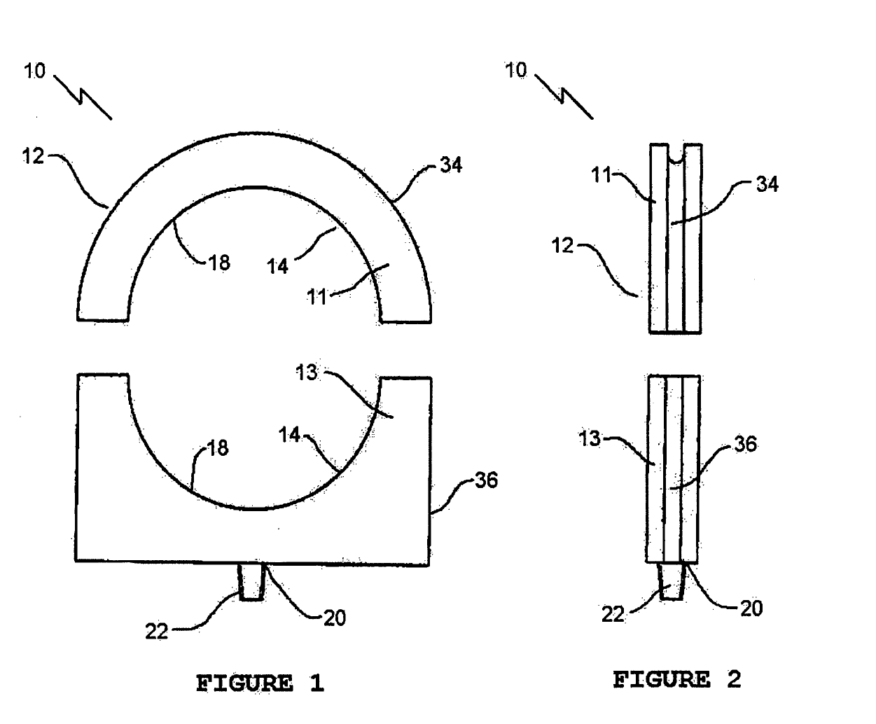

The preferred embodiment, an apparatus for controlling leaks in a pipe connection, generally identified by reference numeral 10, will now be described with reference to FIGS. 1 through 6.

Structure and Relationship of Parts:

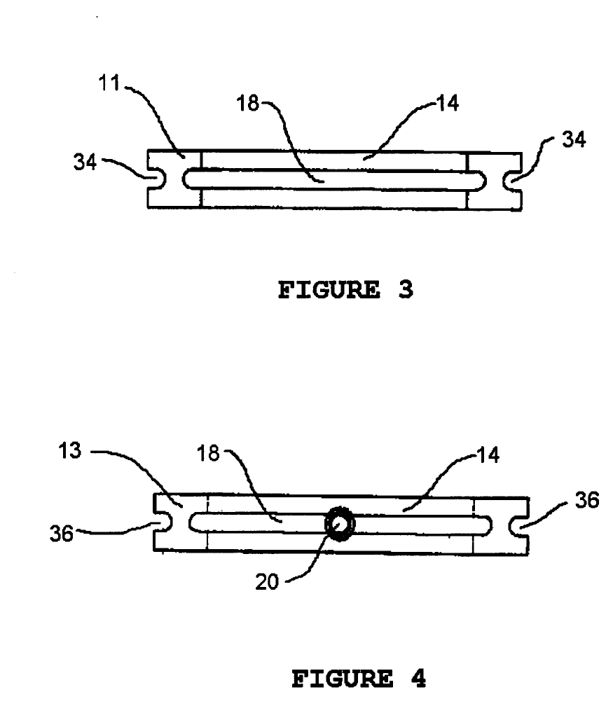

Referring to FIG. 1, apparatus 10 includes a clamp 12 having a circular clamping face 14. Referring to FIG. 6, clamp 12 is adapted to clamp around a pipe connection 16. Referring to FIGS. 3 and 4 in circular clamping face 14 of the clamp 12, there is positioned a diversion channel 18, as can be seen by the views in FIG. 3, looking at the clamping face 14 of the top half 11 of clamp 12, and FIG. 4, looking at the clamping face 14 of the bottom half 13 of clamp 12. The diversion channel 18 forms an indent in clamping face 14, and extends substantially circumferentially around the circular clamping face 14 of the clamp 12. Referring to FIG. 1, the diversion channel 18 ensures that any fluid that escapes from any part of pipe connection 16 will be directed toward a drain outlet 20, which is in communication with diversion channel 18. A conduit attachment fitting 22 is positioned on drain outlet 20, to facilitate the attachment of a hose or other type of conduit.

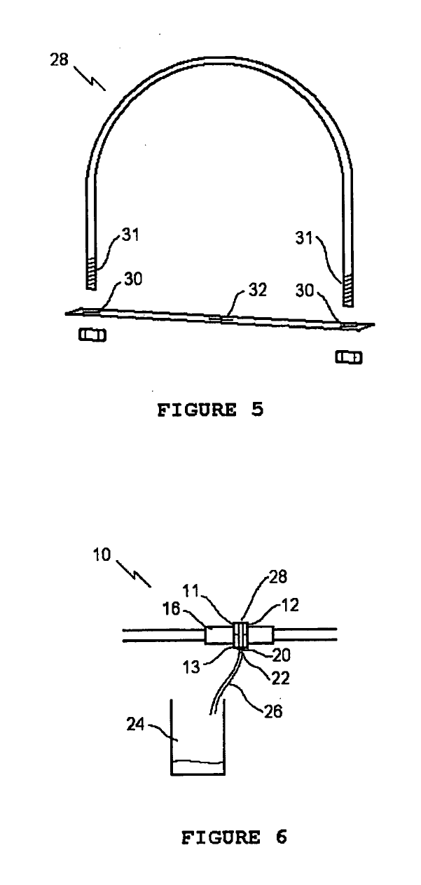

The clamp may be held together by a variety of methods. FIG. 1 shows the clamp with two mating halves, a top half 11 and a bottom half 13. A “U” bolt 28, as shown in FIG. 5, is used to secure the two mating halves 11 and 13 together. The U-bolt 28 in FIG. 5 comprises a clamping piece with holes 30 for the ends 31 of U-bolt 28, and a hole 32 for the drain fitting 22. Referring to FIG. 2, the U-bolt 28 is adapted to fit in groove 34 in the outer face of the top half 11 of clamp 12, and in groove 36 in the outer face of the bottom half 13 of clamp 12.

Operation:

Referring now to FIG. 6, once is it desired that a joint 16 be protected against leaks, the first step is obtaining a clamp 12 having a circular clamping face 14 with a diversion channel 18 positioned in the circular clamping face 14 and a drain outlet 20 in communication with the diversion channel 18, as described above. The clamp 12 is clamped around a pipe connection 16 so that any fluids leaking from the pipe connection 16 can only escape by being diverted to the diversion channel 18. Diversion channel 18, in turn, diverts the liquid to drain outlet 20. A container 24 is positioned relative to the drain outlet 20, so that any fluids passing through the drain outlet 20 from the diversion channel 18 are captured in the container 24. This may be accomplished by providing a conduit, such as hose 26, which connects to drain outlet 20 by means of conduit attachment fitting 22 and extends down to the container 24.

Variations:

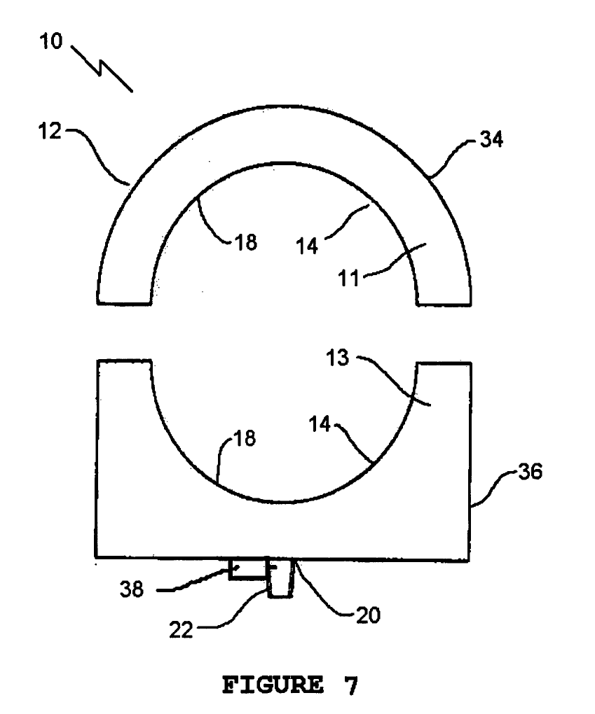

The method and apparatus, as described above, was developed for use in controlling gas or liquid leaks during maintenance. When pipe connections are loosened, there is always the possibility that there is a fluid residue remaining which will leak. The method and apparatus addresses safety and environmental concerns associated with such leakage. The method and apparatus, as described above, can also be used to control gas or liquid leaks which occur spontaneously, until repair crews have the opportunity to repair them. Referring to FIG. 7, if proactive steps are to be taken against leakage, apparatus 10 can be adapted to detect leaks. In this embodiment, a sensor 38 is positioned where it can sense any fluids which pass from diversion channel 18 through drain outlet 20 and conduit attachment fitting 22 into conduit 26. In the illustrated embodiment sensor 38 is mounted on conduit attachment fitting 22 and is in fluid communication with drain outlet 20. Apparatus 10 can then be positioned on any pipe connection which is suspect, but is not, as yet leaking. If a fluid leak occurs, such leak is not only controlled, but immediate notification is give of the leak via sensor 38. Sensor 38 can be connected to any form of alarm notification circuit.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope of the invention as hereinafter defined in the claims.

The embodiments of the invention in which an exclusive property or privilege is claimed are defined as follows:

1. An apparatus for controlling fluid leaks in a pipe connection, comprising:
a clamp having a circular clamping face adapted to clamp around a pipe connection;
a diversion channel positioned in the circular clamping face of the clamp; and
a drain outlet in communication with the diversion channel.

2. The apparatus as defined in claim 1, wherein a conduit attachment fitting is positioned on the drain outlet.

3. The apparatus as defined in claim 1, wherein the diversion channel extends substantially circumferentially around the circular clamping face of the clamp.

4. The apparatus as defined in claim 1, wherein the clamp has two mating halves.

5. The apparatus as defined in claim 4, wherein a “U” bolt is used to secure the two mating halves together.

6. The apparatus as defined in claim 1, wherein a sensor is in fluid communication with one of the diversion channel or the drain outlet.

7. A method for controlling fluids leaks in a pipe connection, comprising the steps of:
providing a clamp having a circular clamping face with a diversion channel positioned in the circular clamping face and a drain outlet in communication with the diversion channel;
clamping the clamp around a pipe connection so that any fluids leaking from the pipe connection can only escape by being diverted to the diversion channel;
positioning a container relative to the drain outlet, so that any fluids passing through the drain outlet from the diversion channel are captured in the container.

8. The method as defined in claim 7, a conduit extending from the drain outlet to the container.

9. The method as defined in claim 7, a sensor being in fluid communication with one of the diversion channel or the drain outlet.
